(19) United States
(12) Patent Application Publication
(10) Pub. No.: US 2026/0128557 A1
(43) Pub. Date: May 7, 2026

(54) CONNECTOR ASSEMBLY

(71) Applicant: YAZAKI CORPORATION, Tokyo (JP)

(72) Inventor: Kazuya Tsubaki, Susono-shi (JP)

(21) Appl. No.: 19/380,966

(22) Filed: Nov. 6, 2025

(30) Foreign Application Priority Data
Nov. 7, 2024 (JP) 2024-194889

(51) Int. Cl. H01R 13/703

(52) U.S. Cl. CPC H01R 13/703; H01R 2201/26

(57) ABSTRACT

A connector assembly includes a first connector, a second connector, and a lever-type connector. A base can be formed by a first housing of the first connector and a second housing of the second connector. Further, the lever-type connector is configured to be detachably fitted to the base to allow first wirings and provided in the first connector, and second wirings provided in the second connector, to be releasably connected via connecting wirings provided in the lever-type connector.

### CROSS-REFERENCE TO RELATED APPLICATIONS

The present application is based on, and claims priority from the Japanese Patent Application No. 2024-194889, filed on Nov. 7, 2024, the entire contents of which are incorporated herein by reference.

### TECHNICAL FIELD

The disclosure relates to a connector assembly.

### BACKGROUND

JP2012-243559A discloses a conventional connector assembly. JP2012-243559A discloses a connector assembly including a first connector, a second connector able to engage with and disengage from the first connector, and a lever rotatably attached to the second connector. The connector assembly disclosed in JP2012-243559A is further provided with a switch including a terminal provided on the first connector and a terminal provided on the second connector. The switch is turned on and off by rotating the lever to engage and disengage the first connector and the second connector.

### SUMMARY OF THE INVENTION

It is desirable that the connector assembly, in which a switch is turned on and off by operating a lever, can be installed in various locations.

The present disclosure has been made in view of such a problem of the conventional technology. It is an object of the present disclosure to provide a connector assembly which can be versatile in its installation locations.

A connector assembly includes: a first connector including a first housing and a first wiring held in the first housing; a second connector including a second housing and a second wiring held in the second housing, and formed separately from the first connector; and a lever-type connector including a third housing, a connecting wiring held in the third housing, and a lever rotatably attached to the third housing. The first housing of the first connector and the second housing of the second connector are configured to form a base without the first wiring and the second wiring being connected, and the lever-type connector is configured to be detachably fitted to the base to allow the first wiring and the second wiring to be releasably connected via the connecting wiring.

According to the present disclosure, it is possible to provide a connector assembly that can be versatile in its installation locations.

### BRIEF DESCRIPTION OF DRAWINGS

FIG. 1 is an exploded perspective view schematically illustrating an example of a connector assembly.

FIG. 2 is a wiring diagram schematically illustrating an example of the connector assembly.

FIG. 3 is a perspective view schematically illustrating an example of a first engaging portion and a second engaging portion.

FIG. 4 is a perspective view schematically illustrating a state in which a base is formed by a first housing and a second housing.

FIG. 5 is a perspective view schematically illustrating a state in which a base is fixed by a fixing plate.

FIG. 6 is a perspective view schematically illustrating a state in which a lever-type connector is fitted to a base.

FIG. 7 is a view for explaining an example of a method of assembling a vehicle using an example connector assembly, schematically illustrating a state before assembly of a front module, a center module, and a rear module.

FIG. 8 is a view for explaining an example of a method of assembling a vehicle using an example connector assembly, schematically illustrating a state in which a front module, a center module, and a rear module are assembled.

FIG. 9 is a view for explaining an example of a method of assembling a vehicle using an example connector assembly, schematically illustrating a state in which a base is formed.

FIG. 10 is a view for explaining an example of a method of assembling a vehicle using an example connector assembly, schematically illustrating a state in which a lever-type connector is fitted to a base.

### DETAILED DESCRIPTION OF THE INVENTION

Hereinafter, a connector assembly according to the present embodiment will be described in detail with reference to the drawings. It should be noted that the dimensional ratios of the drawings are exaggerated for the sake of explanation, and may be different from the actual ratio.

In the following embodiments, a direction in which a first housing and a second housing are aligned when a base is formed is defined as a front-rear direction, and a direction in which a lever-type connector is fitted to the base is defined as a vertical direction. A direction intersecting the front-rear direction and the vertical direction is defined as a width direction.

Further, when describing the connector assembly, the vertical direction of each member is defined in a state where the lever-type connector is fitted to the base by moving the lever-type connector relative to the base from an upper side to a lower side. A front side of the first connector in the front-rear direction is defined by a side facing the second connector, and a front side of the second connector in the front-rear direction is defined by a side facing the first connector.

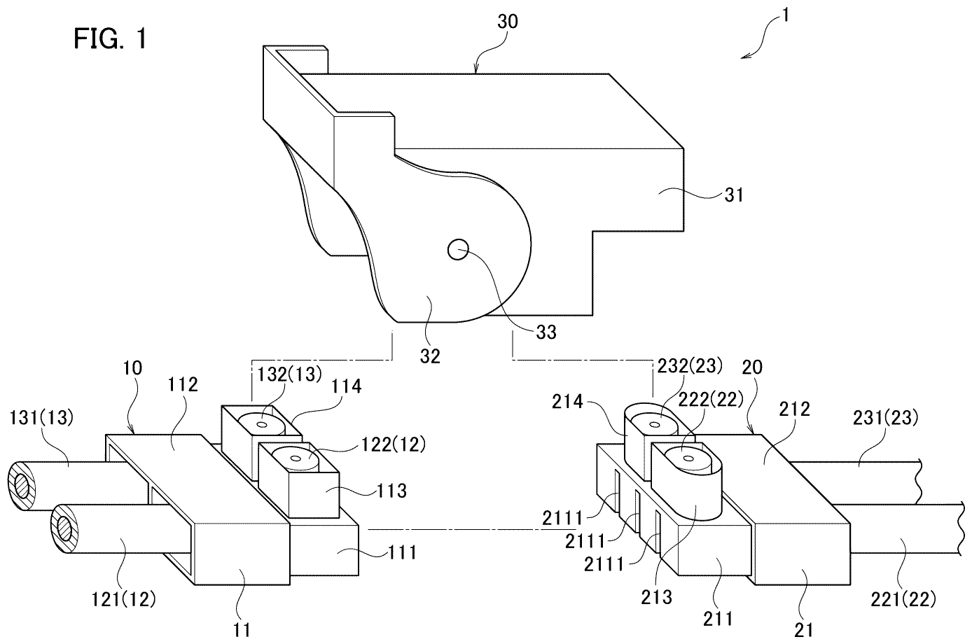

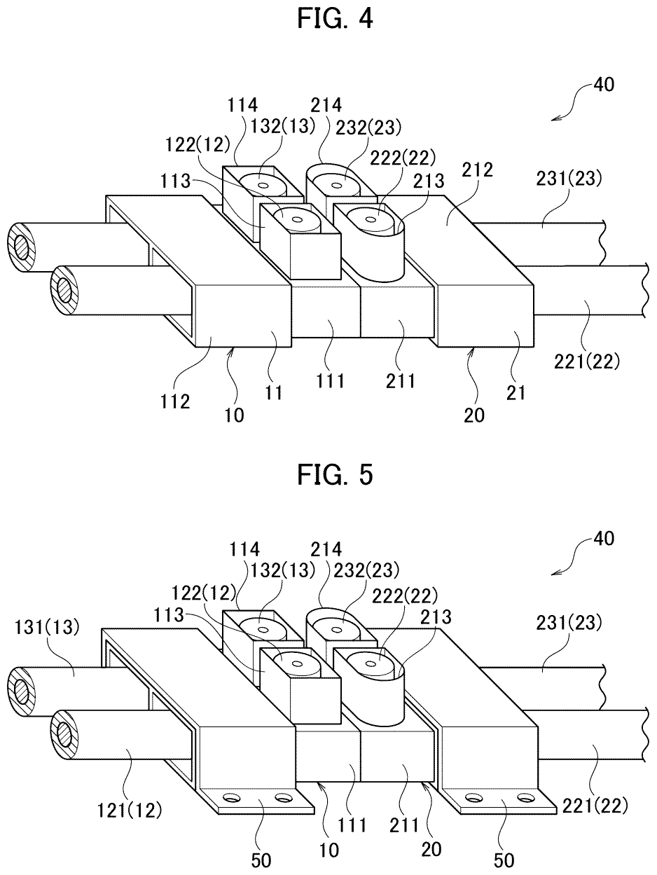

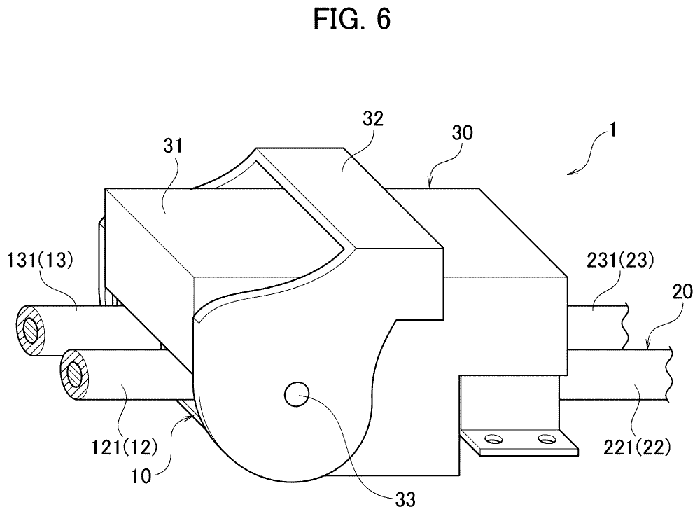

As illustrated in FIGS. 1 to 6, a connector assembly 1 according to this embodiment includes a first connector 10 including a first housing 11 and a first wiring, and a second connector 20 including a second housing 21 and a second wiring. In this embodiment, the second connector 20 is formed separately from the first connector 10, and a base 40 can be formed by the first housing 11 of the first connector 10 and the second housing 21 of the second connector 20. The base 40 can be formed without the first wiring and the second wiring being connected.

The connector assembly 1 includes a lever-type connector 30 including a third housing 31, a connecting wiring held by the third housing 31, and a lever 32 rotatably attached to the third housing 31.

By detachably fitting the lever-type connector 30 to the base 40, the first wire and the second wire are detachably connected via the connecting wiring.

Specifically, the lever 32 is attached to the third housing 31 to be rotatable around a rotary shaft 33. With the third housing 31 temporarily held by the base 40, the lever 32 is rotated in a predetermined direction to fit the third housing 31 to the base 40. The connecting wiring is electrically connected to the first wire and the second wire by fitting the third housing 31 to the base 40. Thus, the first wire and the second wire are electrically connected by the connecting wiring.

Further, with the third housing 31 fitted to the base 40, the lever 32 is rotated in a direction opposite to the predetermined direction to release the fitting between the third housing 31 and the base 40. The connecting wiring is separated from the first wiring and the second wiring by disengaging the third housing 31 from the base 40. Thus, the electrical connection between the first wiring and the second wiring is released.

The connector assembly 1 can be used, for example, as a connector for an automobile to electrically connect electric components such as connecting a power supply to a device or connecting a device to a device.

This embodiment exemplifies the connector assembly 1 used as a power supply circuit interrupter called a service plug for disconnecting power supply between a power supply and a load in order to ensure work safety in the maintenance, or the like of an electric system in a vehicle such as an electric vehicle or a hybrid vehicle.

Specifically, the first housing 11 includes a first front housing 111 located on a front side (facing the second housing 21) and a first rear housing 112 connected to a rear end of the first front housing 111. In this embodiment, both the first front housing 111 and the first rear housing 112 have a substantially rectangular parallelepiped shape, and the first rear housing 112 is wider than the first front housing 111. Two spaces are provided inside the first front housing 111 and the first rear housing 112, and open rearward, the two spaces being aligned in a width direction. A first power supply wiring 12 as a first wiring, and a first ground wire 13 as a first wiring, are accommodated in the two spaces.

In this embodiment, the first power supply wiring 12 includes a first power supply line 121 and a first power supply terminal 122. A first power supply hood 113 opening upward is formed at an upper end of the first front housing 111 to communicate with the space inside the first front housing 111. The first power supply terminal 122 is accommodated in the first power supply hood 113 with the first power supply wire 121 being accommodated in the spaces formed in the first front housing 111 and the first rear housing 112.

Similarly, the first ground wiring 13 includes a first ground wire 131 and a first ground terminal 132. A first ground hood 114 opening upward is formed at an upper end of the first front housing 111 to communicate with the space inside the first front housing 111. The first ground terminal 132 is accommodated in the first ground hood 114 with the first ground wire 131 being accommodated in the spaces formed in the first front housing 111 and the first rear housing 112.

The first housing 11 can be made of an electrically insulating material such as a synthetic resin.

Further, the second housing 21 includes a second front housing 211 located on a front side (facing the first housing 11), and a second rear housing 212 connected to a rear end of the second front housing 211. In this embodiment, the second front housing 211 and the second rear housing 212 also have a substantially rectangular parallelepiped shape, and the second rear housing 212 is wider than the second front housing 211. Two spaces that open rearward are provided inside the second front housing 211 and the second rear housing 212, the two spaces being aligned in a width direction. A second power supply wiring 22 and a second ground wiring 23 are accommodated in these two spaces as respective second wirings.

In this embodiment, the second power supply wiring 22 includes a second power supply wire 221 and a second power supply terminal 222. A second power supply hood 213 opening upward is formed at an upper end of the second front housing 211 to communicate with the space inside the second front housing 211. The second power supply terminal 222 is accommodated in the second power supply hood 213, with the second power supply wire 221 being accommodated in the spaces formed in the second front housing 211 and the second rear housing 212.

Similarly, the second ground wiring 23 includes a second ground wire 231 and a second ground terminal 232. A second ground side hood 214 opening upward is formed at an upper end of the second front housing 211 to communicate with the space inside the second front housing 211. The second ground terminal 232 is accommodated in the second ground side hood 214, with the second ground wire 231 being accommodated in the spaces formed in the second front housing 211 and the second rear housing 212.

The second housing 21 can also be formed of an electrically insulating material such as a synthetic resin.

Further, a space opening downward is formed inside the third housing 31, and a power supply side connecting wiring 34 and a ground side connecting wiring 35, are accommodated in this space as connecting wirings.

In this embodiment, the power supply side connecting wiring 34 includes a first power supply side connecting terminal 341, a second power supply side connecting terminal 342, and a power supply side connecting wire 343 for connecting the first power supply side connecting terminal 341 and the second power supply side connecting terminal 342.

The first power supply side connecting terminal 341 and the first power supply terminal 122 connect to and separate from each other, and the second power supply side connecting terminal 342 and the second power supply terminal 222 connect to and separate from each other in accordance with the engagement and disengagement of the third housing 31 with the base 40.

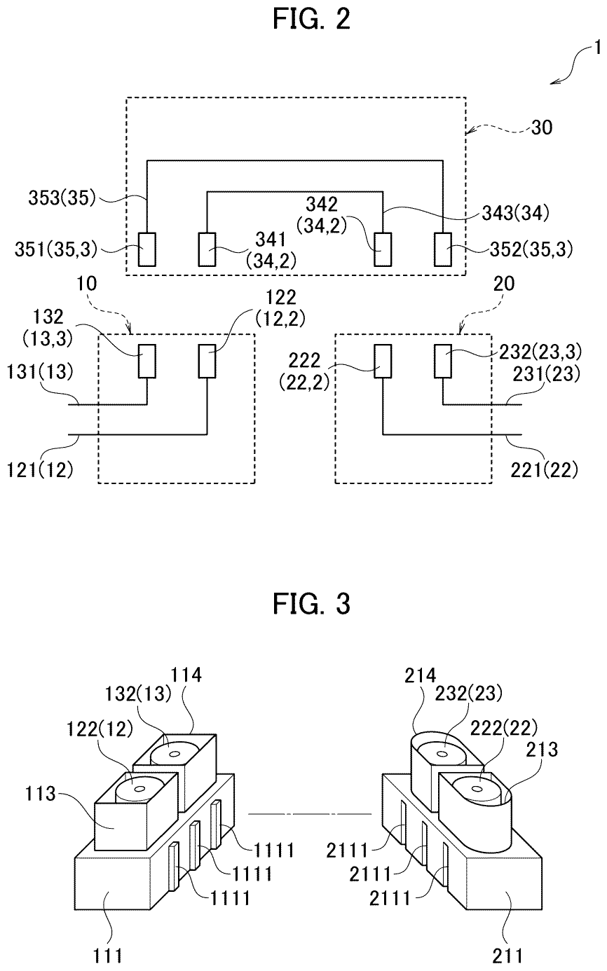

Thus, in this embodiment, the first power supply side connecting terminal 341 and the first power supply terminal 122, and the second power supply side connecting terminal 342 and the second power supply terminal 222, function as a power switch 2 configured to be a part of the power supply circuit (see FIG. 2).

The ground side connecting wiring 35 includes a first ground side connecting terminal 351, a second ground side connecting terminal 352, and a ground side connecting wire 353 for connecting the first ground side connecting terminal 351 and the second ground side connecting terminal 352.

The first ground side connecting terminal 351 and the first ground terminal 132 connect to and separate from each other, and the second ground side connecting terminal 352 and the second ground terminal 232 connect to and separate from each other in accordance with the engagement and disengagement of the third housing 31 with the base 40.

Thus, in this embodiment, the first ground side connecting terminal 351 and the first ground terminal 132, and the second ground side connecting terminal 352 and the second ground terminal 232, function as a ground switch 3 configured to be a part of a ground circuit (see FIG. 2).

Further, in this embodiment, engagement projections (first engagement portions) 1111 are formed on a front surface of the first front housing 111, and engagement recesses (second engagement portion) 2111 are formed on a front surface of the second front housing 211, as illustrated in FIG. 3. When the base 40 is formed by the first housing 11 and the second housing 21, the engagement projections (first engagement portions) 1111 formed on the first front housing 111 are engaged with the engagement recesses (second engagement portions) 2111 formed on the second front housing 211. Thus, when the base 40 is formed, the displacement of the first housing 11 relative to the second housing 21 can be controlled, and the lever-type connector 30 can be more easily and reliably fitted to the base 40.

In this embodiment, the connector assembly 1 is fixed to a member, to which the connector assembly 1 is mounted, using fixing plates 50 in a state where the base 40 is formed by the first housing 11 and the second housing 21, as illustrated in FIG. 5. Thus, the lever-type connector 30 can be more easily and reliably fitted to the base 40.

Further, although not illustrated, fitting portions are formed inside the third housing 31 each to be detachably fitted to the first power supply side hood 113, the first ground side hood 114, the second power supply side hood 213, and the second ground side hood 214. The contour shape of hood parts on the first housing 11 is different from the contour shape of hood parts on the second housing 21. Thus, it is possible to prevent the lever-type connector 30 from being fitted in a wrong direction (reverse direction).

In the present embodiment, the base 40 is formed by using the first connector 10 and the second connector 20 formed of separate and independent members, and the lever-type connector 30 is fitted to and detached from the base 40, as described above. Thus, the connector assembly 1 is imparted with a function as a service plug for switching between electrical connection and disconnection between a power supply and a load.

With this configuration, the connector assembly 1 can be formed even when the first connector 10 is installed on one side, and the second connector 20 is installed on the other side, of divided members to be joined to each other.

For example, even when adopting a method of manufacturing a vehicle 90 by joining multiple modules manufactured in advance, the connector assembly 1 can be used to connect a battery 71 to a load installed in a module different from the module in which the battery 71 is installed, in such manner that the battery 71 and the load can be disconnected.

Hereinafter, a method of connecting the battery 71 to a load using the connector assembly 1 will be described. The vehicle 90 is manufactured by joining a front module 60, a center module 70, and a rear module 80 that have been manufactured in advance. The method described below is only an example, and the vehicle 90 can be manufactured by a method other than the method described below. The number of modules prepared in advance is not limited to three, but may be two, four, or more.

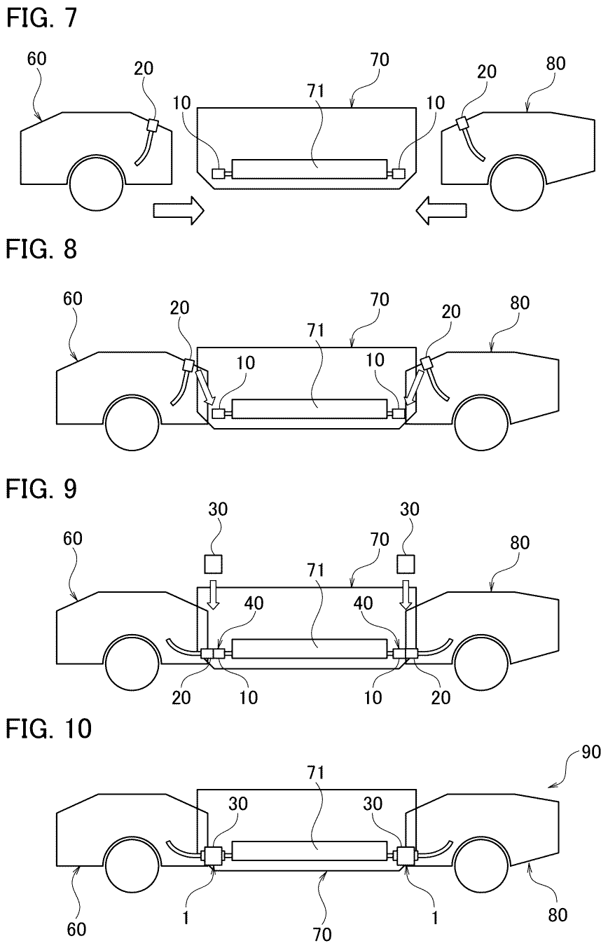

First, as illustrated in FIG. 7, when the center module 70 is manufactured, a first wiring of the first connector 10 is connected to the battery 71 installed in the center module 70. Further, when the front module 60 is manufactured, a second wiring of the second connector 20 is connected to a load installed in the front module 60. Similarly, when the rear module 80 is manufactured, a second wiring of the second connector 20 is connected to a load installed in the rear module 80. The load includes an inverter.

Then, as illustrated in FIG. 8, a rear end of the front module 60 is joined to a front end of the center module 70 by welding or the like. Further, a front end of the rear module 80 is joined to a rear end of the center module 70 by welding or the like.

Then, as illustrated in FIG. 9, the base 40 is formed by connecting the first housing 11 of the first connector 10 and the second housing 21 of the second connector 20. Specifically, the base 40 is formed by engaging the engagement protrusions (first engagement portions) 1111 formed in the first front housing 111 with the engagement recesses (second engagement portions) 2111 formed in the second front housing 211. Then, the base 40 is fixed to a floor plate, or the like, that is formed in the joined module by using a fixing plate 50 or the like.

Then, as illustrated in FIG. 10, the loads installed in the front module 60 and the rear module 80 are connected to the battery 71 installed in the center module 70 by fitting the lever-type connector 30 to the base 40. Thus, the vehicle 90 is formed.

When the connector assembly 1 is used, the lever-type connector 30 can be removed at the time of maintenance or accident response. This allows work to be performed while the power supply to the load is shut off, so that work safety can be ensured. Moreover, it is possible to judge whether power is supplied or power supply is shut off by visually confirming the state of the lever-type connector 30. Therefore, it is possible to prevent work from being performed erroneously in a state where power is supplied.

### Operation and Effect

Hereinafter, a description will be given of a characteristic configuration of the connector assembly illustrated in the embodiment above and effects obtained thereby.

The connector fitting combination 1 illustrated in the embodiment above includes the first connector 10 including the first housing 11 and first wirings (the first power supply wiring 12 and the first ground wiring 13) held in the first housing 11.

Further, the connector assembly 1 includes the second connector 20 including the second housing 21 and second wirings (the second power supply wiring 22 and the second ground wiring 23) held in the second housing 21 and formed separately from the first connector 10.

Further, the connector assembly 1 includes the lever-type connector 30 including the third housing 31, connecting wirings (the power supply side connecting wiring 34 and the ground side connecting wiring 35) held in the third housing 31, and the lever 32 rotatably attached to the third housing 31.

The first housing 11 of the first connector 10 and the second housing 21 of the second connector 20 are configured to form the base 40 without the first wiring and the second wiring being connected.

The lever-type connector 30 is detachably fitted to the base 40 to allow the first wiring and the second wiring to be releasably connected via the connecting wiring.

As described above, in the connector assembly 1 described in the embodiment above, the first connector 10 and the second connector 20 are formed of separate members, and the base 40 is formed by the first housing 11 of the first connector 10 and the second housing 21 of the second connector 20. The first wirings (the first power supply wiring 12 and the first ground wiring 13) and the second wirings (the second power supply wiring 22 and the second ground wiring 23) are prevented from being connected. When the first wirings (the first power supply wiring 12 and the first ground wiring 13) and the second wirings (the second power supply wiring 22 and the second ground wiring 23) are connected, the lever-type connector 30 is fitted to the base 40.

This makes it possible to form the connector assembly 1 even when the first connector 10 is installed on one side and the second connector 20 is installed on the other side of divided members to be joined to each other. That is, not only the first connector 10 and the second connector 20 are installed on the same member, but also the first connector 10 and the second connector 20 can be installed on each of the divided members.

Therefore, with the connector assembly 1 described in the embodiment above, it is possible to provide versatility in the installation locations of the first connector 10 and the second connector 20.

Further, when the base 40 is formed, the engagement protrusions (first engagement portions) 1111 formed in the first housing 11 may be engaged with the engagement recesses (second engagement portion) 2111 formed in the second housing 21.

In this manner, it is possible to control displacement of the first housing 11 relative to the second housing 21 when the base 40 is formed, so that the lever-type connector 30 can be fitted to the base 40 more easily and reliably.

### Others

The present embodiment has been described above. However, the present embodiment is not limited thereto, and various modifications are possible within the gist of the present embodiment.

For example, in the embodiment above, when the base 40 is formed, the engagement protrusions 1111 of the first housing 11 are configured to be engaged with the engagement recesses 2111 of the second housing 21. However, the configuration for engaging the first housing 11 and the second housing 21 is not limited thereto, and various configurations are possible.

It is also possible to provide no engagement portion between the first housing 11 and the second housing 21. In this case, it is preferable to fix an end face of the first housing 11 to an end face of the second housing 21 by using a fixing plate or the like while the end faces are in contact with each other.

The first wiring, the second wiring, and the connecting wiring can be formed by using an electric wire or a bus bar.

Further, the connector assembly 1 can be used for a purpose other than assembly of divided modules, and can be used for a purpose other than a service plug.

Moreover, the first housing, the second housing, and other detailed specifications (shape, size, layout, or the like) can be changed as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector assembly comprising:
a first connector including a first housing and a first wiring held in the first housing;
a second connector including a second housing and a second wiring held in the second housing, and formed separately from the first connector; and
a lever-type connector including a third housing, a connecting wiring held in the third housing, and a lever rotatably attached to the third housing, wherein
the first housing of the first connector and the second housing of the second connector are configured to form a base without the first wiring and the second wiring being connected, and
the lever-type connector is configured to be detachably fitted to the base to allow the first wiring and the second wiring to be releasably connected via the connecting wiring.

2. The connector assembly according to claim 1, wherein a first engagement portion formed on the first housing, and a second engagement portion formed on the second housing, are engaged with each other when the base is formed.
